(19) United States
(12) Patent Application Publication
(10) Pub. No.: US 2002/0178937 A1
(43) Pub. Date: Dec. 5, 2002

(54) Drive mechanism for a transfer rail in a press transfer system

(76) Inventors: Montgomery W. Childs, Barrie (CA); Malcolm Broadley, Barrie (CA)

Correspondence Address: MEREK & VOORHEES, 643-B South Washington Street, Alexandria, VA, 22314, US

(21) Appl. No.: 09/866,632

(22) Filed: May 30, 2001

(51) Int. Cl. B30B 15/30

(52) U.S. Cl. 100/215

(57) ABSTRACT

A drive mechanism for a transfer rail in a press transfer system having a drive frame for imparting reciprocating movement to the transfer rail. The drive mechanism comprises a drive housing securable to a transfer rail in the press transfer system, a drive bushing received and secured within the drive housing, and a drive member slidably received within the drive bushing and securable to the drive frame of the press transfer system such that movement of the drive frame causes movement of the drive member in a direction generally corresponding to the direction of the movement of the drive frame. The movement of the drive member is transmitted through the drive bushing to the drive housing and the transfer rail causing movement of the transfer rail in a direction generally parallel to the movement of the drive frame.

### FIELD OF THE INVENTION

This invention relates to a drive mechanism for a transfer rail used in a press transfer system.

### BACKGROUND OF THE INVENTION

The manufacturing industry, and in particular the metal fabrication and stamping industries, commonly utilize automated systems that allow a workpiece to be conveyed or transferred between equally spaced workstations where particular operations are carried out upon the workpiece. For example, many metal parts on automobiles and appliances are formed by means of a stamping procedure wherein a series of separate dies are situated on a series of aligned and equally spaced workstations within a press bed such that a workpiece will be stamped between a pair of dies upon each stroke of the press. Automated transfer systems are typically employed to grasp the workpiece, remove it from one set of dies, and transport it laterally through the press bed to the next adjacent workstation where the workpiece will be stamped a second time with a further set of dies upon the next stroke of the press. A press transfer system utilized in conjunction with a typical multi-stage press would commonly include at least one transversely oriented transfer rail situated adjacent to the press bed and aligned with the various workstations. Depending upon the particular application and press design, a single transfer rail may be positioned along one side of the press bed or, alternatively, a separate transfer rail may be located on each side of the bed of the press. Regardless, the primary function of the transfer rail is to provide a mechanism by which grippers or fingers may be supported adjacent to the workstations for grasping a workpiece so that it may be transported to the next workstation. Such grippers or fingers would typically be mounted either to the transfer rail or to a secondary rail that is in some manner secured or attached to the transfer rail. Movement of the workpieces from workstation to workstation accordingly involves the movement of the transfer rail, often in a relatively complex three dimensional manner. Described generally, this movement involves (i) moving the rail toward the workstation such that the grippers may grasp the workpiece; (ii) lifting upwardly to remove the workpiece from the dies in the workstation; (iii) moving laterally and parallel to the press bed to align the workpiece with the next adjacent workstation; (iv) lowering to allow the grippers to release the workpiece onto the next adjacent set of dies; and, (v) retracting from the workstation and returning back to the starting position.

It will therefore be appreciated that to present an effective mechanism by which a workpiece may be moved in the above-described fashion, the transfer rails must be relatively rigid, must be of a sufficient strength to support workpieces without significant flexure or deflection from the horizontal, and preferably of a relatively light weight construction so as to minimize the inertia of the moving transfer rails to permit more precise and faster movement of workpieces between workstations.

In order to maximize production efficiency in metal fabrication and stamping operations, press operators require a press transfer system that is capably of quickly grasping and transferring workpieces from one workstation to the next in synchronous movement with the cycling of the press. Optimum press throughput can only be achieved when the press transfer system is capable of moving parts through the press bed when the press is operating at its maximum speed. The requirement to grasp and move workpieces from workstation to workstation requires a press transfer system that is capable of quickly moving in the three dimensional manner as described above so that a workpiece may be placed upon the next adjacent set of dies before the next cycle of the press. Such movement necessitates very fast acceleration and deceleration of the transfer rail and other components of the transfer system, together with the workpiece itself. The short, fast and somewhat jerky movements of the press transfer system tend to place a significant amount of strain upon the transfer rail and the various components of the transfer system. The strain and load borne by the transfer rail tend to be considerably enhanced when relatively large or heavy workpieces are involved and where there is a resulting increase in the inertia of the moving parts during acceleration and deceleration. To help reduce the inertia of the moving parts in a press transfer system, the elongate transfer rails have traditionally been formed from aluminum extrusions. Aluminum has proven to provide a means to reduce the weight of the transfer rail while at the same time providing sufficient strength to support the workpieces and other components attached to the transfer rail. Unfortunately, with the advantages gained through the use of light weight transfer rails also come certain disadvantages. Currently designed press transfer systems, and more particularly systems known as “through-the-window” transfer systems, employ methods of imparting movement to their transfer rails that have a tendency to cause the rails to be deflected from the horizontal during operation. In particular, during the very quick and somewhat jerky movements of the transfer rail in a direction parallel to the press bed, currently available systems have demonstrated a tendency to cause the rails to develop a wave-like or sinusoidal motion along their longitudinal axes. Such wave-like or sinusoidal motion is more pronounced in press transfer systems that are utilized on a multi-stage press having transfer rails that are of an extended length.

It will be appreciated that any significant degree of deflection of a transfer rail in either an upwardly or downwardly direction can have a devastating affect on the positioning of component parts secured thereto, including the grippers or fingers. In such cases the grippers may not properly grasp a workpiece causing the workpiece to be dropped or, alternatively, may result in the workpiece not being deposited upon an adjacent workstation in the required position causing the workpiece to be destroyed upon the next stroke of the press. Further, wave-like or sinusoidal movement of the transfer rail has the tendency of causing internal vibrations in the press transfer system and creating undesireable flexure and strain within its various components.

### SUMMARY OF THE INVENTION

The invention therefore provides a drive mechanism for a transfer rail in a press transfer system that addresses a number of the limitations in prior drive mechanisms through providing a mechanism to drive the transfer rail in a direction parallel to the press bed without the tendency of imparting a wave-like or sinusoidal motion to the transfer rail, while at the same time not significantly increasing the mass of either the rail or its drive system.

Accordingly, in one of its aspects the invention provides a drive mechanism for a transfer rail in a press transfer system having a drive frame for imparting reciprocating movement to the transfer rail, the drive mechanism comprising a drive housing securable to a transfer rail in the press transfer system; a drive bushing received and secured within said drive housing; and, a drive member slidably received within said drive bushing and securable to the drive frame of the press transfer system such that movement of the drive frame causes movement of said drive member in a direction generally corresponding to the direction of the movement of the drive frame, the movement of said drive member transmitted through said drive bushing to said drive housing and the transfer rail causing movement of the transfer rail in a direction generally parallel to the movement of the drive frame.

In a further aspect the invention provides A drive mechanism for a transfer rail in a press transfer system, the drive mechanism comprising a drive bushing securable to a transfer rail of the press transfer system; a drive frame, said drive frame reciprocated by the press transfer system in a back and forth in a direction generally parallel to the transfer rail; and, a drive member having one end fixed to said drive frame such that said drive member and said drive frame move together, said drive member slidably received within said drive bushing such that movement of said drive frame results in movement of the transfer rail in a generally parallel direction to the direction of the movement of said drive frame.

Further advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is an upper side perspective view of a press having attached thereto a “through-the-window” press transfer system employing an embodiment of the transfer rail drive mechanism according to the present invention;

FIG. 2 is a side elevational view of the press shown in FIG. 1;

FIG. 3 is a rear side elevational view of a press transfer system generally constructed in accordance with the prior art;

FIG. 4 is a side elevational view of the press transfer system shown in FIG. 3;

FIG. 5 is a rear perspective view of a press transfer system employing a drive mechanism for a transfer rail in accordance with a preferred embodiment of the present invention;

FIG. 6 is a side elevational view of the press transfer system shown in FIG. 5;

FIG. 7 is a sectional view taken along the line 7-7 of the FIG. 6; and,

FIG. 8 is an upper side perspective view of the transfer rail drive mechanism according to a preferred embodiment of the invention.

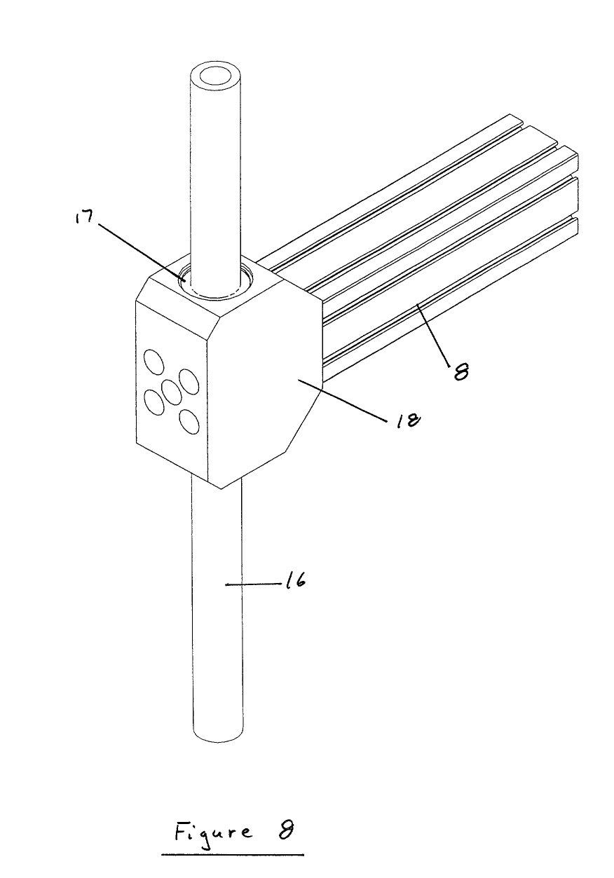

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

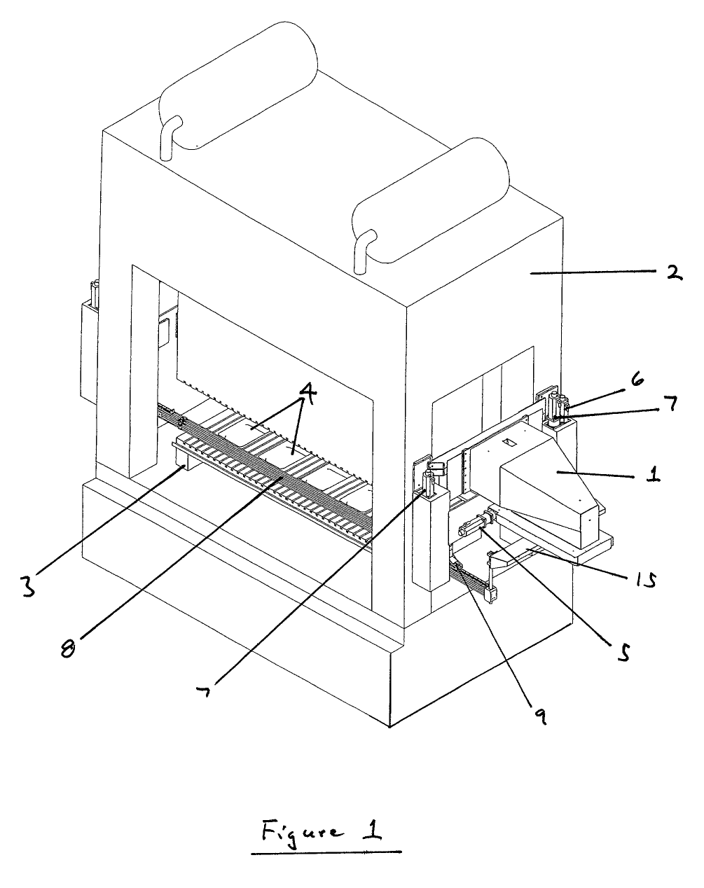

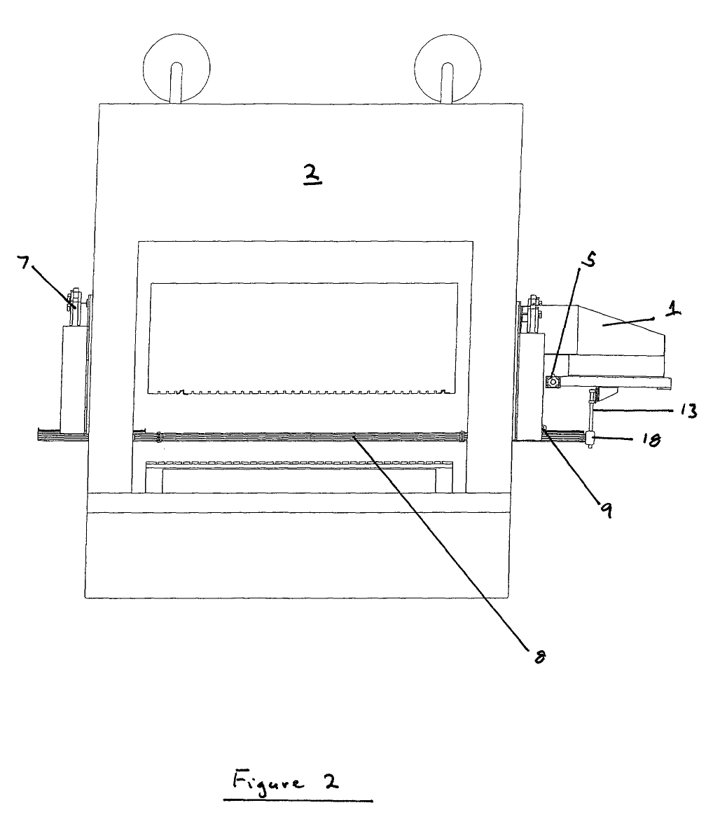

FIGS. 1 and 2 represent a general schematic view of a press having attached thereto a through-the-window press transfer system that employs a drive mechanism for its transfer rails constructed in accordance with a preferred embodiment of the present invention. In FIGS. 1 and 2 the press transfer system is noted generally by reference numeral 1 and the press to which it is attached is identified by reference numeral 2.

Press 2 has a press bed 3 and a series of aligned workstations 4. So as to create a frame of reference with respect to the movement of the components of transfer system 1, movement in a horizontal direction parallel to press bed 3 is generally referred to as movement in the “X” direction, movement horizontally inwardly and outwardly from workstations 4 is designated as movement in the “Y” direction, and vertical movement is designated as movement in the “Z” direction. In the particular embodiment of the press transfer system shown in FIGS. 1 and 2, movement in the X, Y, and Z directions is accomplished by means of one more “X” drive motors 5, “Y” drive motors 6, and “Z” drive motors 7.

Press transfer system 1 includes a transfer rail 8 extending through the press window and positioned parallel to workstations 4. Depending upon the particular operation in concern and the configuration of press 2, a single transfer rail may be positioned along one side of the press bed or, alternatively, a pair of transfer rails may extend along both sides of press bed 3. In the embodiment of the press transfer system shown in FIGS. 1 and 2, a foot 9 is positioned at each corner of the press in order to secure each end of transfer rail 8 to the press transfer system. In FIGS. 1 and 2 feet 9 are also the components which impart movement to transfer rail 8 in the “Y” direction.

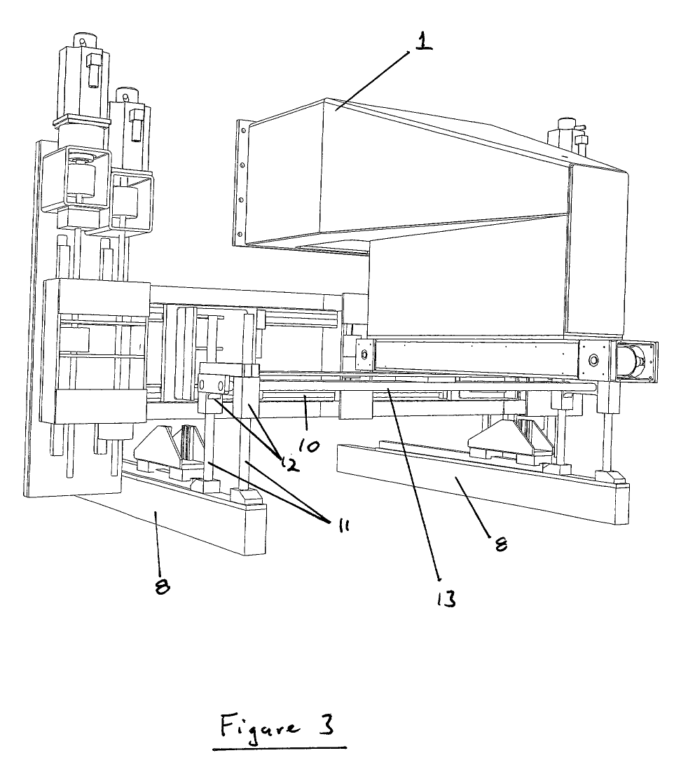

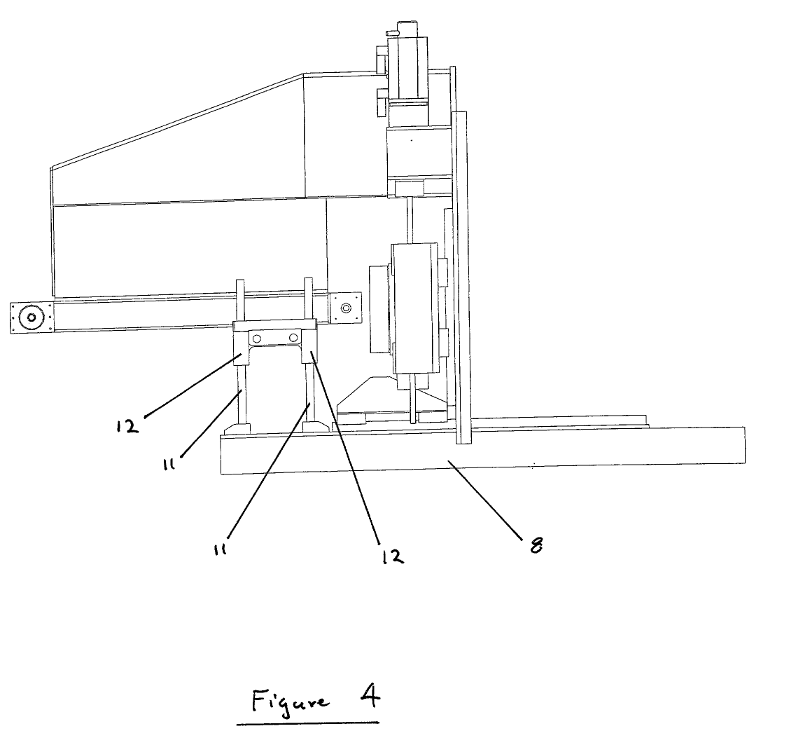

FIGS. 3 and 4 represent a typical press transfer system having a drive mechanism for its transfer rail generally designed in accordance with prior existing devices. As shown in FIGS. 3 and 4, press transfer systems currently in use typically employ a transfer rail 8 connected to an “X” drive frame 10 by means of a pair of generally vertically oriented bars or posts 11. Posts 11 are rigidly secured to the upper surface of transfer rail 8 to resist movement therebetween. Posts 11 are permitted to slide upwardly or downwardly within a set of drive bushings 12 so as to permit transfer rail 8 to be raised or lowered in the “Z” direction movement of transfer rail 8 in the “X” direction is accomplished through the operation of an “X” drive member 13 which would typically be comprised of a belt, chain, jack screw or similar device, the function of which is to move “X” drive frame 10 in a direction parallel to transfer rail 8 and press bed (i.e. in the “X” direction). It will be appreciated that movement of “X” drive frame 10 will cause a corresponding movement of drive bushings 12 that are attached thereto, which in turn transfer movement in the “X” direction through posts 11 to transfer rail 8.

While the above described structure is relatively efficient in the transfer of energy from the drive system to transfer rail 8, imparting movement to transfer rail 8 by the application of force applied through rigidly attached posts 1 1 that are driven at a vertical, spaced apart, distance from the upper surface of the transfer rail imparts a bending moment to the transfer rail. That is, since the transfer rail is being driven through posts 11 that are rigidly fixed to the transfer rail, the distance along the length of the posts between the upper surface of the transfer rail and drive bushing 12 effectively represents a moment arm that causes torque to be built up within the transfer rail. It will therefore be appreciated that as the press transfer system cycles through its various movements when transporting a workpiece between workstations on the press, a series of cyclical bending moments will be established within posts 11 and transfer rail 8. Furthermore, the bending moments (and the resulting torque) will alternate, in terms of direction, as the movement of transfer rail 8 in the “X” direction is constantly reversing. The result of the complex forces that are applied to the transfer rail through this structure is a tendency for the rail to be deflected vertically from its horizontal position and the establishment of a wave-like or generally sinusoidal motion within the transfer rail. The extent and amplitude of the wave-like motion is enhanced with an increase in the length of the transfer rail and/or an increase in the weight of workpieces and other components attached thereto.

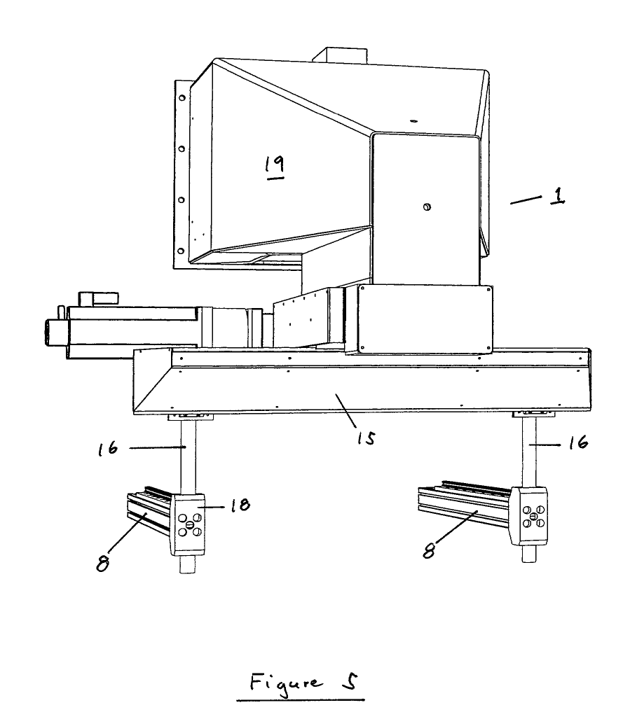

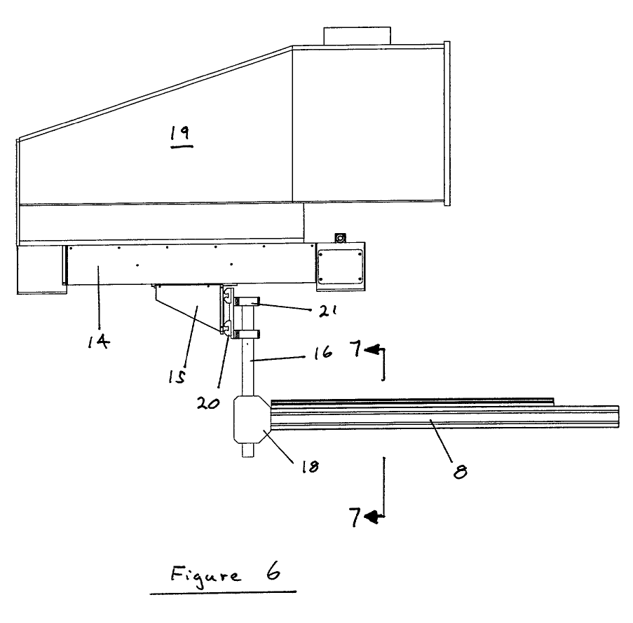

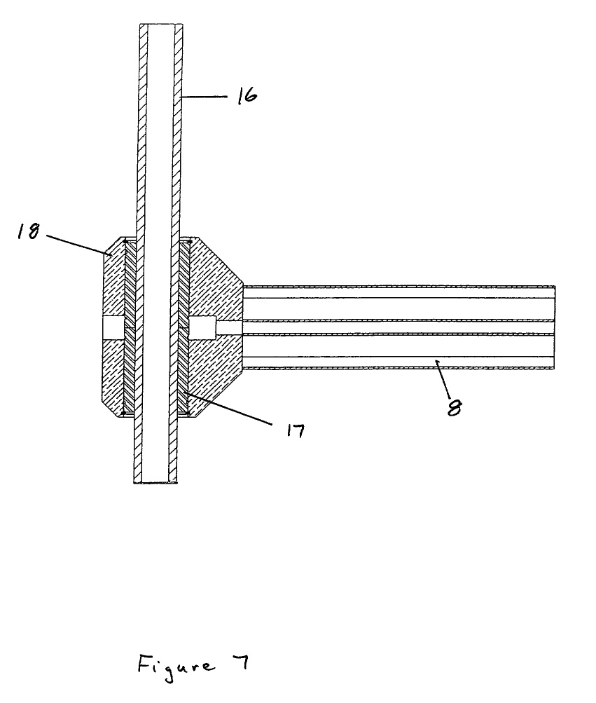

In contrast to the drive mechanism shown in FIGS. 3 and 4, FIGS. 5, 6, and 7 depict a drive mechanism for a transfer rail in a press transfer system in accordance with a preferred embodiment of the present invention. Referring specifically to FIG. 6, there is shown a press transfer system having an “X” drive system 14 for imparting movement to a transfer rail 8 in a direction that (as described previously) is generally parallel to the press bed. “X” drive system 14 is itself comprised of a number of different components. It will be appreciated from a thorough understanding of the invention that the precise construction and configuration of the “X” drive system could vary substantially from press transfer system to press transfer system without affecting the scope of the present invention. For illustrative purposes, the “X” drive system shown in the attached drawings is comprised of a generally horizontally mounted drive frame 15 (shown most clearly in FIGS. 1 and 5) that is moved in the “X” direction by means of “X” drive motor 5, in conjunction with one or more belts, chains, jack screws, or other commonly used mechanical structures that transmit motion. In the embodiment of the press transfer system shown in FIGS. 5 through 7, a number of the components of “X” drive system 14 and other features of the transfer system are concealed within a nose cone 19.

To transfer the reciprocating motion of drive frame 15 to transfer rail 8, in the preferred embodiment there is utilized a drive member 16 having one end rigidly connected to drive frame 15 and an opposite end slideably received within a drive bushing 17 secured to one end of transfer rail 8. Drive bushing 17 may be attached directly to the end of the transfer rail or, alternatively, may be received and secured within a drive housing 18, that is in turn secured to the end of transfer rail 8. Regardless, with the fixation of one end of drive member 16 to drive frame 15, and through the receipt of the drive member within drive bushing 17 which is either directly connected to transfer rail 8 or indirectly connected by means of drive housing 18, reciprocal movement of drive frame 15 in a direction parallel to the press bed will result in a corresponding reciprocal movement of the transfer rail in the same direction. In the embodiment depicted in the attached drawings drive member 16 is rigidly secured to a bearing attachment plate 20 through the use of one or more collars 21. Bearing attachment plate 20 is in turn fixed to drive frame 15. The attachment of the drive bushing and/or drive housing to the end of transfer rail 8, rather than to its sides or top surfaces, helps to reduce the torque and bending moment developed within the rail as it is driven by drive member 16. To further help minimize the bending moment applied to transfer rail 8, in the preferred embodiment drive bushing 17 is a self-aligning bushing and drive member 16 is a post slideably received within bushing 17. Through utilizing a self-aligning bushing to transmit force between the drive post 16 and transfer rail 8, it will be appreciated that there will be presented the ability for the angle between drive post 16 and transfer rail 8 to be automatically adjusted in accordance with the reciprocal motion of the drive post. That is, in essence the connection between self-aligning bushing 17 and drive post 16 will be “free floating” allowing the drive post to be deflected in a direction either toward or away from the end of transfer rail 8 as the post is reciprocated back and forth. In this manner the moment arm imparted to transfer rail 8 will be minimized and less than would be the case if the drive post were rigidly fixed directly to the transfer rail. The use of self-aligning bushing 17 to transfer movement between drive post 16 and transfer rail 8 allows for the angle of the post relative to the transfer rail to be automatically varied as the drive housing reverses direction during its reciprocal movement.

Self-aligning drive bushing 17 also helps to accommodate any deflection that may occur within drive post 16 upon the reversing of direction of movement of drive housing 15. Specifically, upon the reversal of the reciprocating moment of drive frame 15, there will be an inertia within the moving transfer rail having a tendency to deflect drive post 16 from its generally vertical orientation. Self-aligning drive bushing 17 permits any such deflection to be accommodated without a significant increase in the moment arm or torque applied to the transfer rail. The combined affect of the function and operation of drive post 16 and self-aligning drive bushing 17 is to reduce the moment arm and torque applied to transfer rail 8 and the resulting wave-like or sinusoidal motion that is often imparted to a transfer rail through the use of prior existing drive mechanisms.

With drive post 16 slideably received within self-aligning drive bushing 17, there will also be presented the ability for transfer rail 8 to be raised or lowered in the “Z” direction without affecting the “X” drive assembly. That is, a separate drive mechanism (not shown) would typically be utilized to raise or lower transfer rail 8 at which time self-aligning drive bushing 17 merely slides upwardly or downwardly along drive post 16. Once again, due to the nature and relationship between self-aligning drive bushing 17 and drive post 16, inertia in the “X” direction that is present within transfer rail 8 when it is moved in an upwardly or downwardly direction can be accommodated through self-aligning drive bushing 17.

It is to be understood that what has been described are the preferred embodiments of the invention and that it may be possible to make variations to these embodiments while staying within the broad scope of the invention. Some of these variations have been discussed while others will be readily apparent to those skilled in the art.

We claim:

1. A drive mechanism for a transfer rail in a press transfer system having a drive frame for imparting reciprocating movement to the transfer rail, the drive mechanism comprising:
a drive housing securable to a transfer rail in the press transfer system;
a drive bushing received and secured within said drive housing; and,
a drive member slidably received within said drive bushing and securable to the drive frame of the press transfer system such that movement of the drive frame causes movement of said drive member in a direction generally corresponding to the direction of the movement of the drive frame, the movement of said drive member transmitted through said drive bushing to said drive housing and the transfer rail causing movement of the transfer rail in a direction generally parallel to the movement of the drive frame.

2. The device as claimed in claim 1 wherein said drive member is rigidly secured to the drive frame of the press transfer system

3. The device as claimed in claim 1 wherein said drive bushing is a self-aligning bushing such that the angle between said drive member and the transfer rail is varied in response to the movement of the drive frame and the transfer rail and in response to the inertia of the drive frame and the transfer rail.

4. The device as claimed in claim 3 wherein the variation of said angle between said drive member and the transfer rail minimizes the moment arm applied to the transfer rail through movement of the drive frame.

5. The device as claimed in claim 4 wherein said drive member comprises a drive post, said drive post having one end rigidly secured to the drive frame, said drive post slidably received within said drive bushing to permit the transfer rail and said drive housing to be raised or lowered through slidably moving said drive bushing along said drive post.

6. The device as claimed in claim 5 including a drive plate, said drive plate securing said drive post to the drive frame and transferring movement from the drive frame to said drive post.

7. A drive mechanism for a transfer rail in a press transfer system, the drive mechanism comprising:
a drive bushing securable to a transfer rail of the press transfer system;
a drive frame, said drive frame reciprocated by the press transfer system in a back and forth in a direction generally parallel to the transfer rail; and,
a drive member having one end fixed to said drive frame such that said drive member and said drive frame move together, said drive member slideably received within said drive bushing such that movement of said drive frame results in movement of the transfer rail in a generally parallel direction to the direction of the movement of said drive frame.

8. The device as claimed in claim 7 wherein said drive member is rigidly secured to said drive frame.

9. The device as claimed in claim 7 wherein said bushing is a self-aligning bushing such that the angle between said drive member and the transfer rail is varied upon the reciprocation of said drive frame in a back and forth direction generally parallel to the transfer rail, said variation of the angle between said drive member and the transfer rail minimizing the moment arm applied to the transfer rail through movement of said drive frame.

10. The device as claimed in claim 9 wherein said drive member comprises a drive post having one end rigidly secured to said drive frame, said drive post slidably received within said drive bushing to permit the transfer rail and said drive housing to be raised or lowered through slidably moving said drive bushing along said drive post.

11. The device as claimed in claim 10 wherein said drive bushing is securable to an end of the transfer rail.
